(19) United States
(12) Patent Application Publication
(10) Pub. No.: US 2018/0258248 A1
(43) Pub. Date: Sep. 13, 2018

(54) LARGE-DIAMETER HEAT-EXPANDING MICROSPHERES AND METHOD FOR PRODUCING SAME

(71) Applicant: Kureha Corporation, Tokyo (JP)

(72) Inventors: Tetsuo EJIRI, Tokyo (JP); Tomohisa HASEGAWA, Tokyo (JP); Daisuke SATO, Tokyo (JP); Kazunori SATOU, Tokyo (JP); Mitsuhiro MATSUZAKI, Tokyo (JP)

(21) Appl. No.: 15/531,586

(22) PCT Filed: Dec. 2, 2015
(86) PCT No.: PCT/JP2015/083878

§ 371 Date: May 30, 2017

(30) Foreign Application Priority Data
Dec. 2, 2014 (JP) 2014-243774

(51) Int. Cl. C08J 9/20; C08J 9/224; C08J 9/232; C08F 12/08

(52) U.S. Cl. CPC C08J 9/20; C08J 9/224; C08J 9/232; C08F 12/08; C08J 2203/14; C08J 2203/22; C08J 2433/10; C08J 2333/20; C08J 2425/06; C08J 2427/08; C08J 2431/04; C08J 2433/02; C08J 2433/08; C08J 2207/00

(57) ABSTRACT

Object:

To provide heat-expandable microspheres with which large-diameter foamed particles which are lightweight and have enhanced strength, cushioning properties, and the like can be formed.

Resolution Means:

Heat-expandable microspheres having a foaming agent encapsulated in an outer shell of a polymer, the heat-expandable microspheres having an average particle size (D50) before foaming of from 100 to 500 μm, and a coefficient of variation of a particle size distribution before foaming (logarithmic scale) of not greater than 15%.

### TECHNICAL FIELD

The present invention relates to heat-expandable microspheres and a method for producing heat-expandable microspheres, and more particularly to heat-expandable microspheres capable of forming strong, large-diameter foamed particles, a molded product or the like containing the heat-expandable microspheres or the foamed particles, and a method for producing heat-expandable microspheres.

### BACKGROUND ART

In addition to applications as a foamed ink, the applications of heat-expandable microspheres (also called “heat-expandable microcapsules”) are spreading to various fields such as fillers for paints or plastic molded products for the purpose of weight reduction. Heat-expandable microspheres are ordinarily formed by microencapsulating a volatile liquid foaming agent (also called a “physical foaming agent”, a “volatile expanding agent”, or the like) with a polymer. A chemical foaming agent which degrades and produces a gas when heated may also be used as a foaming agent as desired. Heat-expandable microspheres may typically be produced by a method of performing suspension polymerization on a polymerizable mixture containing at least a foaming agent and a polymerizable monomer in an aqueous dispersion medium containing a dispersion stabilizer. As the polymerization reaction progresses, an outer shell is formed by the polymer that is produced, and heat-expandable microspheres having a structure in which the foaming agent is encapsulated in the outer shell are obtained.

For example, Patent Document 1 discloses particles of a unicellular thermoplastic resinous polymer (that is, heat-expandable microspheres) having a particle size of from 1 to 50 μm with a volatile liquid foaming agent which becomes gaseous at a temperature equal to or lower than the softening point of the polymer encapsulated therein. Patent Document 1 describes a method of adding a foaming agent with a low boiling point such as an aliphatic hydrocarbon to a monomer, mixing an oil-soluble catalyst into this monomer mixture, adding the monomer mixture to an aqueous dispersion medium containing a dispersant while stirring, and performing suspension polymerization so as to produce spherical particles having a foaming agent encapsulated in an outer shell made of a thermoplastic resin. Expandable particles having a diameter of approximately 2 to 10 microns (Examples 1 to 52, 54, 57, and 61 to 63), approximately 2 to 5 microns (Example 53), approximately 2 to 5 microns (Example 55), and approximately 0.3 to 3 microns (Example 64) are described as specific examples. Patent Document 1 also describes that it is often advantageous to use large particles in the range of from 50 to 1000 microns.

A thermoplastic resin having good gas barrier properties is typically used as the polymer for forming the outer shell of heat-expandable microspheres. The polymer for forming the outer shell softens when heated. An agent which becomes gaseous at a temperature equal to or lower than the softening point of the polymer is selected as a foaming agent. When the heat-expandable microspheres are heated, the foaming agent vaporizes so that the force of expansion acts on the outer shell, and the modulus of elasticity of the polymer forming the outer shell decreases dramatically. As a result, the heat-expandable microspheres rapidly expand around a certain temperature. This temperature is called the foaming starting temperature (also called the “foaming temperature”, and generally called the “foaming temperature” hereafter). That is, when the heat-expandable microspheres are heated to the foaming temperature, the microspheres themselves expand and form closed cells (also called “foamed particles”, “foam particles”, “hollow particles”, “closed foam”, or “hollow plastic balloons”).

Suspension polymerization, which is performed to form heat-expandable microspheres, is typically performed by adding a polymerizable mixture containing at least a foaming agent and a polymerizable monomer to an aqueous dispersion medium containing a dispersion stabilizer, mixing while stirring, granulating fine liquid droplets of the polymerizable liquid, and then heating the liquid droplets. Since most polymerizable mixtures are ordinarily insoluble in water, an oil phase is formed in the aqueous dispersion medium, so the polymerizable mixtures are granulated into fine liquid droplets by mixing while stirring. Heat-expandable microspheres having substantially the same particle size as the fine liquid droplets are formed by suspension polymerization. In the suspension polymerization method, the particle shape or particle size distribution can be adjusted by appropriately selecting and combining the types and contents of various additives such as a dispersion stabilizer, a stabilization aid (also called an “auxiliary stabilizer”), a polymerization initiator (also called a “catalyst”), or a polymerization aid and appropriately selecting and combining the stirring and mixing conditions, the polymerization conditions, or the like.

Utilizing the characteristic that heat-expandable microspheres form closed cells when heated to the foaming temperature, the applications of heat-expandable microspheres are spreading in a wide range of fields as design-imparting materials, functionality-imparting materials, weight-reducing materials, and the like. As higher performance is demanded in each of these fields of application, the demand level of the heat-expandable microspheres is also increasing. For example, an example of the required performance of heat-expandable microspheres is the improvement of processing characteristics. In addition, there is a method of obtaining a molding or molded product (sheet or the like) with a reduced weight or a design by performing kneading, calendering, extruding, thermoforming, stamp molding, or injection molding on a composition prepared by compounding heat-expandable microspheres with a thermoplastic resin to foam heat-expandable microspheres in the processing. Further, heat-expandable microspheres are not only compounded with inks, paints, plastics or the like in an unfoamed state, but may also be used in a foamed state depending on the application. That is, since closed foams (hollow plastic balloons) formed by the expansion of heat-expandable microspheres are extremely lightweight, they can be used as fillers for pains or fillers for molded products such as sheets so as to reduce the weight of coating films or molded product.

Patent Document 2 discloses a method for producing heat-expandable microcapsules, wherein heat-expandable microcapsules having a large particle size can be produced with good productivity while suppressing agglomeration. Specifically, Patent Document 2 describes that with a method of performing foaming by adding heat-expandable microcapsules having a volatile liquid encapsulated as a core agent in a shell containing a polymer to a base material resin, the shell of the heat-expandable microcapsules functions as a reinforcing material so that the strength and fatigue resistance with respect to repeated compression are enhanced in comparison to cases in which a chemical foaming agent which degrades and produces a gas when heated is used, but when heat-expandable microcapsules are used, it is difficult to make the air bubbles inside the foam molded article large, and the performance in terms of cushioning properties or damping or weight reduction is insufficient, so there is a demand for heat-expandable microcapsules which have a large particle size and with which large air bubbles can be formed after foaming.

Patent Document 2 describes that the volume average particle size of the obtained heat-expandable microcapsules is not particularly limited, but a preferable lower limit is 40 μm, and a preferable upper limit is 80 μm. Patent Document 2 also describes that when the volume average particle size is less than 40 μm and the heat-expandable microcapsules are compounded with a base material resin and molded, the air bubbles of the foam molded article are too small due to a low expansion ratio, which causes the performance in terms of cushioning properties or damping or weight reduction to be insufficient, whereas when the volume average particle size exceeds 80 μm, the air bubbles of the foam molded article are too large due to a high expansion ratio, which causes the strength or fatigue resistance with respect to repeated compression to be insufficient. Patent Document 2 discloses examples in which the average particle size is from 42 to 76 μm and comparative examples in which the average particle size is from 32 to 85 μm as specific examples.

Further, Patent Document 3 discloses heat-expandable microcapsules including a polymer containing from 15 to 75 wt. % of a nitrile-based monomer, from 10 to 65 wt. % of a monomer having a carboxyl group, from 0.1 to 20 wt. % of a monomer having an amide group, and from 0.1 to 20 wt. % of a monomer having a cyclic structure on a side chain as an outer shell and having a foaming agent encapsulated therein as heat-expandable microcapsules having excellent heat resistance and solvent resistance, and excellent foaming performance even in a temperature range of 200° C. or higher. Patent Document 3 describes that the average particle size of the heat-expandable microcapsules is from approximately 1 to 500 μm, preferably from approximately 3 to 100 μm, and even more preferably from 5 to 50 μm, and examples and comparative examples of heat-expandable microcapsules having an average particle size of from approximately 12 μm to approximately 30 μm as specific examples.

In addition, Patent Document 4 discloses producing hollow microspheres having a solid material adhered to an outer shell surface using heat-expandable microspheres having an average particle size within the range of from 0.5 to 150 μm. Patent Document 4 describes heat-expandable microspheres having an average particle size of 14 μm as a specific example.

Therefore, there has been a demand for the provision of large-diameter heat-expandable microspheres with an average particle size of not less than 100 μm, for example, having a foaming agent encapsulated in an outer shell of a polymer, the microspheres having enhanced strength or the like, having an average particle size of not less than 300 μm and preferably from 500 to 2000 μm, and being suitable for the formation of foamed particles from the perspective of the enhancement of the fatigue resistance or strength of a molded product, performance in terms of cushioning properties or damping, and weight reduction under the assumption of applications to molded products having foamed particles formed by thermally expanding the heat-expandable microspheres.

Specifically, there has been a demand for the provision of heat-expandable microspheres having a foaming agent encapsulated in an outer shell of a polymer, wherein large-diameter foamed particles which are lightweight and have enhanced strength, cushioning properties, and the like can be formed; and a production method thereof.

### CITATION LIST

### Patent Literature

Patent Document 1: JP-B-42-26524

Patent Document 2: JP-A-2013-212432

Patent Document 3: WO 2004/58910

Patent Document 4: WO 2010/70987

### SUMMARY OF INVENTION

### Technical Problem

An object of the present invention is to provide heat-expandable microspheres with which large-diameter foamed particles which are lightweight and have enhanced strength, cushioning properties, and the like can be formed; and a production method thereof.

### Solution to Problem

As a result of diligent research to solve the problem described above, the present inventors discovered that the problem can be solved by forming heat-expandable microspheres having a distinctive average particle size and coefficient of variation of particle size distribution and having a foaming starting temperature equal to or higher than a prescribed temperature as desired, and completed the present invention.

Specifically, the present invention provides (1) heat-expandable microspheres having a foaming agent encapsulated in an outer shell of a polymer, the heat-expandable microspheres having an average particle size (D50) before foaming of from 100 to 500 μm, and a coefficient of variation of a particle size distribution before foaming (logarithmic scale) of not greater than 15%.

The present invention also provides the heat-expandable microspheres of (2) to (5) below as specific aspects of the invention related to heat-expandable microspheres.

(2) The heat-expandable microspheres according to (1), wherein an average particle size of foamed particles formed by thermally expanding the heat-expandable microspheres is from 200 to 1000 μm.
(3) The heat-expandable microspheres according to (1) or (2), wherein a polymerizable monomer forming the polymer is a monomer mixture containing from 25 to 100 mass % of at least one type selected from the group consisting of acrylonitrile and methacrylonitrile and from 0 to 75 mass % of at least one type selected from the group consisting of vinylidene chloride, acrylic acid esters, methacrylic acid esters, styrene, acrylic acid, methacrylic acid, and vinyl acetate.
(4) The heat-expandable microspheres according to (1) or (2), wherein a polymerizable monomer forming the polymer is a monomer mixture containing from 30 to 95 mass % of vinylidene chloride and from 5 to 70 mass % of at least one type selected from the group consisting of acrylonitrile, methacrylonitrile, acrylic acid esters, methacrylic acid esters, styrene, acrylic acid, methacrylic acid, and vinyl acetate.
(5) The heat-expandable microspheres according to any one of (1) to (4), wherein a foaming starting temperature is not lower than 150° C.

In addition, the present invention provides: (6) a paint or molded product containing the heat-expandable microspheres according to any one of (1) to (5); and (7) a laminate having a coating film containing foamed particles formed by thermally expanding the heat-expandable microspheres according to any one of (1) to (5), or a molded product containing the foamed particles.

The present invention further provides: (8) a method for producing the heat-expandable microspheres according to any one of (1) to (5) including performing suspension polymerization on a polymerizable mixture containing at least a foaming agent and a polymerizable monomer in an aqueous dispersion medium containing a dispersion stabilizer so as to produce heat-expandable microspheres having a foaming agent encapsulated in an outer shell of the produced polymer; and, as specific aspects thereof, (9) the method for producing the heat-expandable microspheres according to (8) including dispersing the aqueous dispersion medium containing a dispersion stabilizer and the polymerizable mixture while stirring using a batch-type high-speed emulsifier/disperser and then performing suspension polymerization; and (10) the method for producing the heat-expandable microspheres according to (8) including supplying the aqueous dispersion medium containing a dispersion stabilizer and the polymerizable mixture into a continuous high-speed rotary high-shear type stirrer/disperser and continuously dispersing both components in the stirrer/disperser while stirring.

### Advantageous Effects of Invention

The present invention provides heat-expandable microspheres having a foaming agent encapsulated in an outer shell of a polymer, the heat-expandable microspheres having an average particle size (D50) before foaming of from 100 to 500 μm, and a coefficient of variation of a particle size distribution before foaming (logarithmic scale) of not greater than 15%. This allows heat-expandable microspheres with which large-diameter foamed particles which are lightweight and have improved strength, cushioning properties, and the like can be formed.

In addition, since the present invention provides a paint or molded product containing the heat-expandable microspheres described above, a laminate having a coating film containing foamed particles formed by thermally expanding the heat-expandable microspheres described above, or a molded product containing the foamed particles, there is an effect that a laminate or a molded product including a coating film which is lightweight and has improved strength, cushioning properties, or the like is provided.

Further, because the present invention provides a method for producing the heat-expandable microspheres described above including performing suspension polymerization on a polymerizable mixture containing at least a foaming agent and a polymerizable monomer in an aqueous dispersion medium containing a dispersion stabilizer so as to produce heat-expandable microspheres having a foaming agent encapsulated in an outer shell of the produced polymer, there is an effect that a method for producing heat-expandable microspheres with which the heat-expandable microspheres can be produced easily is provided.

### DESCRIPTION OF EMBODIMENTS

### I. Heat-Expandable Microspheres Having a Foaming Agent Encapsulated in the Outer Shell of Polymer

The heat-expandable microspheres of the present invention are heat-expandable microspheres having a foaming agent encapsulated in an outer shell of a polymer, an average particle size (D50) before foaming of from 100 to 500 μm, and a coefficient of variation of a particle size distribution before foaming (logarithmic scale) of not greater than 15%.

### 1. Foaming Agent

In the heat-expandable microspheres of the present invention, the foaming agent encapsulated in the outer shell of the polymer is ordinarily a substance which becomes gaseous at a temperature equal to or lower than the softening point of the polymer forming the outer shell. A hydrocarbon or the like having a boiling point corresponding to the foaming starting temperature may be used as a foaming agent, and examples thereof include hydrocarbons such as ethane, ethylene, propane, propene, n-butane, isobutane, butene, isobutene, n-pentane, isopentane, neopentane, n-hexane, heptane, n-octane, isooctane, isododecane, petroleum ethers, and isoparaffin mixtures; chlorofluorocarbons such as CCl₃F, CCl₂F₂, CClF₃, and CClF₂—CClF₂; and tetraalkylsilanes such as tetramethylsilane, trimethylethylsilane, trimethylisopropylsilane, and trimethyl-n-propylsilane. These can be used alone, or two or more types thereof can be combined for use. Of these, isobutane, n-butane, n-pentane, isopentane, n-hexane, isooctane, isododecane, petroleum ethers, and mixtures of two or more types thereof are preferable. In addition, a compound which undergoes thermolysis and becomes gaseous when heated may also be used as desired. The foaming agent is used in an amount in the range of ordinarily from 10 to 40 parts by mass, preferably from 12 to 35 parts by mass, and more preferably from 15 to 32 parts by mass per 100 parts by mass of the polymerizable monomer described below.

### 2. Polymerizable Monomer Forming Polymer

The polymerizable monomer forming the polymer serving as an outer shell of the heat-expandable microspheres of the present invention is not particularly limited as long as a foaming agent can be encapsulated therein and, ordinarily, heat-expandable microspheres having a foaming agent encapsulated in the outer shell of a polymer produced by performing suspension polymerization in an aqueous dispersion medium containing a dispersion stabilizer can be formed, as described below. The polymerizable monomer preferably contains at least one type of monomer selected from the group consisting of acrylonitrile and methacrylonitrile (this monomer may be generally called “(meth)acrylonitrile”) and/or vinylidene chloride from the perspective of ensuring that the outer shell of the polymer has gas barrier properties, solvent resistance, and heat resistance and that a polymer having good foamability as well as foamability at high temperatures can be produced as desired.

Polymerizable monomers other than (meth)acrylonitrile and/or vinylidene chloride are not particularly limited, and examples thereof include acrylic acid esters such as methyl acrylate, ethyl acrylate, butyl acrylate, and dicyclopentenyl acrylate; methacrylic acid esters such as methyl methacrylate, ethyl methacrylate, butyl methacrylate, and isobornyl methacrylate; acrylic acids, methacrylic acids, vinyl chloride, styrene, vinyl acetate, α-methylstyrene, chloroprene, neoprene, and butadiene.

These polymerizable monomers may be respectively used alone or in combinations of two or more types. A preferable polymerizable monomer is a monomer mixture containing (meth)acrylonitrile and/or vinylidene chloride.

### Monomer Mixture Containing (Meth)Acrylonitrile

A monomer mixture containing (meth)acrylonitrile is preferably a monomer mixture in which the polymerizable monomer contains from 25 to 100 mass % of (meth)acrylonitrile (at least one type of monomer selected from the group consisting of acrylonitrile and methacrylonitrile, or a mixture of acrylonitrile and methacrylonitrile) and from 0 to 75 mass % of at least one type of monomer selected from the group consisting of vinylidene chloride, acrylic acid esters, methacrylic acid esters, styrene, acrylic acid, methacrylic acid, and vinyl acetate (also called “monomers other than (meth)acrylonitrile” hereafter) (total content: 100 mass %). Note that the polymerizable monomer does not strictly fall under the category of a monomer mixture when the polymerizable monomer contains 100 mass % of (meth)acrylonitrile, but this case is also called a monomer mixture in the present invention.

The foaming temperature of the heat-expandable microspheres that are formed tends to be higher when the (meth)acrylonitrile content ratio of the monomer mixture containing (meth)acrylonitrile is higher, and the foaming temperature of the heat-expandable microspheres that are formed tends to be lower when the content ratio is lower. In addition, the foaming temperature, the maximum foaming ratio (calculated with a conventional method as the (volume of foamed particles)/(volume of heat-expandable microspheres)), or the like of the heat-expandable microspheres that are formed can also be adjusted based on the types and compositions of monomers other than (meth)acrylonitrile. Therefore, the desired heat-expandable microspheres can be formed by adjusting the ratio of (meth)acrylonitrile and monomers other than (meth)acrylonitrile and the types and compositions of monomers other than (meth)acrylonitrile. A preferable combination of (meth)acrylonitrile and monomers other than (meth)acrylonitrile is a combination of from 25 to 99.5 mass % and more preferably from 30 to 99 mass % of (meth)acrylonitrile and from 0.5 to 75 mass % and more preferably from 1 to 70 mass % of monomers other than (meth)acrylonitrile (total amount: 100 mass %), and methyl methacrylate is particularly preferable as a monomer other than (meth)acrylonitrile. When the content ratio of (meth)acrylonitrile is too low, the foaming temperature of the heat-expandable microspheres that are formed may be too low, or the gas barrier properties may be insufficient.

### Monomer Mixture Containing Vinylidene Chloride

A monomer mixture containing vinylidene chloride is preferably a monomer mixture in which the polymerizable monomer contains from 30 to 95 mass % of vinylidene chloride and from 5 to 70 mass % of at least one type of monomer selected from the group consisting of acrylonitrile, methacrylonitrile, acrylic acid esters, methacrylic acid esters, styrene, acrylic acid, methacrylic acid, and vinyl acetate (also called “monomers other than vinylidene chloride” hereafter) (total content: 100 mass %).

The gas barrier properties of the heat-expandable microspheres that are formed tend to be higher when the vinylidene chloride content ratio of the monomer mixture containing vinylidene chloride is higher, and the gas barrier properties of the heat-expandable microspheres that are formed tend to be lower when the content ratio is lower. In addition, the foaming temperature, the maximum foaming ratio, or the like of the heat-expandable microspheres that are formed can also be adjusted based on the types and compositions of monomers other than vinylidene chloride. Therefore, the desired heat-expandable microspheres can be formed by adjusting the ratio of vinylidene chloride and monomers other than vinylidene chloride and the types and compositions of monomers other than vinylidene chloride. A preferable combination of vinylidene chloride and monomers other than vinylidene chloride is a combination of from 35 to 90 mass % and more preferably from 40 to 80 mass % of vinylidene chloride and from 10 to 65 mass % and more preferably from 20 to 60 mass % of monomers other than vinylidene chloride (total amount: 100 mass %). (Meth)acrylonitrile and methyl methacrylate are preferable as monomers other than vinylidene chloride, and a preferable combination of a monomer mixture containing vinylidene chloride is from 45 to 75 mass % of vinylidene chloride, from 20 to 50 mass % of (meth)acrylonitrile, and from 3 to 10 mass % of methyl methacrylate (total amount: 100 mass %). When the content ratio of vinylidene chloride is too low, the gas barrier properties of the heat-expandable microspheres that are formed may be insufficient, and the desired maximum foaming ratio may not be achieved.

### 3. Crosslinkable Monomer

The polymer serving as the outer shell of the heat-expandable microspheres of the present invention may be formed in combination with a crosslinkable monomer as a monomer in addition to the polymerizable monomer described above in order to enhance the foaming characteristics, heat resistance, and the like. A compound having two or more carbon-carbon double bonds is ordinarily used as a crosslinkable monomer. More specific examples of crosslinkable monomers include divinylbenzene, ethylene glycol di(meth)acrylate, diethylene glycol di(meth)acrylate, triethylene glycol di(meth)acrylate, allyl (meth)acrylate, triallyl isocyanurate, triacrylformal, trimethylolpropane tri(meth)acrylate, 1,3-butylglycol di(meth)acrylate, pentaerythritol tri(meth)acrylate, and pentaerythritol tetra(meth)acrylate. The usage ratio of the crosslinkable monomer is ordinarily from 0.01 to 5 mass %, preferably from 0.02 to 3 mass %, and more preferably from 0.03 to 2 mass % of the total amount of the polymerizable monomer.

### 4. Average Particle Size (D50) and Coefficient of Variation of Particle Size Distribution (Logarithmic Scale)

The heat-expandable microspheres of the present invention have an average particle size (D50) before foaming of from 100 to 500 μm and a coefficient of variation of particle size distribution before foaming (logarithmic scale) of not greater than 15%. That is, because the heat-expandable microspheres of the present invention have a large average particle size (D50) of not less than 100 μm and have an extremely sharp particle size distribution, large-diameter foamed particles which are lightweight and have enhanced strength, cushioning properties, and the like can be formed. From the perspective of ensuring even better uniformity or even better stability of foaming (thermal expansion) and even greater strength or the like of foamed particles formed by thermally expanding the heat-expandable microspheres, the average particle size (D50) of the heat-expandable microspheres before foaming is preferably from 105 to 400 μm and more preferably from 110 to 300 μm, and the coefficient of variation of the particle size distribution of the heat-expandable microspheres before foaming (logarithmic scale) is preferably not greater than 13% and more preferably not greater than 12%. The lower limit of the coefficient of variation of the particle size distribution (logarithmic scale) is not particularly limited, but the value is ordinarily not less than 0.01%.

### (1) Average Particle Size (D50)

The average particle size (D50) of the heat-expandable microspheres is measured using a laser diffraction-type particle size distribution measurement device (SALD series or the like manufactured by the Shimadzu Corporation) and refers to the 50% particle size (also called the “median diameter,” units: μm) obtained based on a particle size distribution curve of the integration % (volume basis and logarithmic scale) of the particle size (sphere equivalent diameter). When the average particle size of the heat-expandable microspheres is too small, there is a risk that the cushioning properties and weight reduction may be insufficient. When the average particle size is too large, the air bubbles of the foam molded article may be too large and that the strength or fatigue resistance with respect to repeated compression may be insufficient.

### (2) Coefficient of Variation of Particle Size Distribution (Logarithmic Scale)

The coefficient of variation of the particle size distribution of the heat-expandable microspheres (also expressed as “Cᵥ” hereafter) is typically known to be defined as a ratio (units: %) of the standard deviation of the particle size to the average particle size calculated from the particle size distribution of the heat-expandable microspheres. The coefficient of variation of the particle size distribution (logarithmic scale) of the heat-expandable microspheres of the present invention is measured and calculated using the laser diffraction-type particle size distribution measurement device described above. Specifically, this is a value calculated by the following Equations (1) and (2) on the basis of the particle size distribution curve of the integration % (volume basis and logarithmic scale) of the particle size (sphere equivalent diameter):

$$\begin{matrix} [ Equation 1 ] & \\ {C}_{v} = [ \sqrt{\frac{1}{100} {\sum }_{j = 1}^{n} {{q}_{j} ( \frac{log {x}_{j} + log {x}_{j + 1}}{2} )}^{2} - {μ}^{2}} / μ ] \times 100 & Equation ( 1 ) \\ [ Equation 2 ] & \\ μ = \frac{1}{100} {\sum }_{j = 1}^{n} {q}_{j} ( \frac{log {x}_{j} + log {x}_{j + 1}}{2} ) & Equation ( 2 )\end{matrix}$$

wherein μ=average value (logarithmic scale), xⱼ=particle size, and qⱼ=frequency distribution, so as to express the following equation:

Coefficient of variation(logarithmic scale)=standard deviation (logarithmic scale)/average value(logarithmic scale)×100. (Equation):

Note that the average value of an ordinary scale of the particle size corresponding to μ=average value (logarithmic scale) described above is 10μ (units: ordinarily μm), and the average value of the ordinary scale of the particle size and the value of the above (D50) are different. When the coefficient of variation of the particle size distribution (logarithmic scale) Cᵥ is too large, the non-uniformity of the particle size of the heat-expandable microspheres becomes large. As a result, there may be an increase in variation in the particle size or strength of foamed particles obtained by foaming (thermally expanding) the heat-expandable microspheres.

### 5. Foaming Starting Temperature

Because the heat-expandable microspheres of the present invention have an average particle size (D50) before foaming of from 100 to 500 μm, a coefficient of variation of the particle size distribution before foaming (logarithmic scale) of not greater than 15%, and a foaming starting temperature (foaming temperature) of not lower than 150° C., better uniformity or better stability of foaming (thermal expansion) is achieved, and large-diameter particles which are lightweight and have improved strength, cushioning properties, and the like can be formed, which is preferable. That is, when an attempt is conventionally made to obtain large-diameter heat-expandable microspheres, the foaming starting temperature tends to decrease dramatically, but decreases in the foaming starting temperature are suppressed by the heat-expandable microspheres of the present invention. The foaming starting temperature of the heat-expandable microspheres can be measured using a thermomechanical analyzer. Specifically, 0.25 mg of heat-expandable microspheres are used as a sample, which is heated at a heating rate of 5° C./min, and the temperature at which a displacement in the height of the sample inside the container begins (also called “Ts” hereafter; units: ° C.) is determined. When the foaming starting temperature of the heat-expandable microspheres is too low, foaming may occur at an early stage of kneading prior to the molding of a molded product containing the heat-expandable microspheres, for example. The foaming starting temperature (Ts) of the heat-expandable microspheres of the present invention is preferably from 152 to 220° C. and more preferably from 155 to 210° C. from the perspective of the uniformity or stability of foaming (thermal expansion). When the foaming starting temperature of the heat-expandable microspheres is too high, it may not be possible to form large-diameter foamed particles.

### II. Foamed Particles Formed by Thermally Expanding Heat-Expandable Microspheres

The heat-expandable microspheres of the present invention are heat-expandable microspheres in which the average particle size of foamed particles formed by thermally expanding the heat-expandable microspheres is preferably from 200 to 1000 μm. That is, the heat-expandable microspheres of the present invention can form large-diameter foamed particles which are lightweight, have improved strength, cushioning properties, or the like, and have an average particle size of from 200 to 1000 μm. The average particle size of the foamed particles is found by observing any 50 foamed particles under a microscope, determining the diameter of each particle, and calculating the average particle size (units: μm) as an average value thereof. From the perspective of better uniformity or better stability of foaming (thermal expansion) or the like, the average particle size of foamed particles formed by thermally expanding the heat-expandable microspheres of the present invention is preferably from 260 to 700 μm, more preferably from 280 to 600 μm, and even more preferably from 300 to 500 μm. The foamed particles formed by thermally expanding the heat-expandable microspheres of the present invention are lightweight and have improved strength, cushioning properties, and the like. That is, although conventional large-diameter foamed particles have insufficient strength, cushioning properties, or the like, the present invention makes it possible to have high shape retention, whereby the shape is retained even in a hot isotropic pressure (HIP) test using argon gas (temperature: 40° C., pressure: 600 kg/cm²), and the shape is retained even in a cold isotropic pressure (CIP) test using water (temperature: 25° C., pressure: 300 kg/cm²). Foamed particles can be obtained by heating the heat-expandable microspheres of the present invention to a temperature exceeding the foaming starting temperature thereof so as to foam the heat-expandable microspheres. In many cases, heating and foaming can be achieved by free foaming at ambient pressure. The heating temperature for obtaining foamed particles is ordinarily in the range of from 150 to 210° C. and in many cases from 160 to 200° C. As described below, the heat-expandable microspheres can be adjusted so that foaming is initiated at a temperature lower than the foaming starting temperature described above by pre-treating the heat-expandable microspheres at a temperature equal to or lower than the foaming starting temperature prior to free foaming.

### III. Applications of Heat-Expandable Microspheres and Foamed Particles

The heat-expandable microspheres obtained by the present invention are used in various fields in a foamed (expansion) state or in an unfoamed state. The heat-expandable microspheres are used in fillers of paints for automobiles or the like, foaming agents for foamed ink (relief patterning for wallpaper, T-shirts, or the like), contraction inhibitors, or the like by utilizing the expandability thereof, for example. In addition, the heat-expandable microspheres may be used for the purpose of reducing weight, making porous, or providing various functions (for example, slipping properties, heat insulation, cushioning properties, sound insulation, or the like) to plastics, paints, or various other materials by utilizing the increase in volume induced by foaming. In particular, the heat-expandable microspheres of the present invention can be suitably used for the weight reduction of paints, inks, or plastic molded products (for example, interior materials or the like) which require surface properties or smoothness.

Therefore, with the present invention, it is possible to provide a paint or molded product containing the heat-expandable microspheres of the present invention, and to provide a laminate having a coating film containing foamed particles formed by thermally expanding the heat-expandable microspheres of the present invention, or a molded product containing the foamed particles. In particular, as described above, a molded product formed by a widely used resin molding method such as kneading, calendering, extruding, thermoforming, stamp molding, or injection molding is provided.

### IV. Method for Producing Heat-Expandable Microspheres

The method for producing heat-expandable microspheres according to the present invention involves performing suspension polymerization on a polymerizable mixture containing at least a foaming agent and a polymerizable monomer in an aqueous dispersion medium containing a dispersion stabilizer so as to produce heat-expandable microspheres having a foaming agent encapsulated in the outer shell of the produced polymer. In the production method of the present invention, the foaming agent, polymerizable monomer, and crosslinkable monomer described above as well as the various additives described below (dispersion stabilizer, polymerization initiator, and the like) are not particularly limited, and conventionally known agents may be used. That is, the production method of the present invention can be applied to the production of all types of heat-expandable microspheres.

### 1. Aqueous Dispersion Medium

In the method for producing heat-expandable microspheres according to the present invention, suspension polymerization is ordinarily performed in an aqueous dispersion medium containing a dispersion stabilizer (suspending agent). Water may be used as an aqueous dispersion medium. Specifically, deionized water or distilled water may be used. The amount of the aqueous dispersion medium that is used with respect to the total amount of the polymerizable monomer is not particularly limited but is ordinarily from 0.5 to 30 times and in many cases from 1 to 10 times (mass ratio).

### 2. Dispersion Stabilizer, Auxiliary Stabilizer, and the Like

Examples of dispersion stabilizers include silica, calcium phosphate, magnesium hydroxide, aluminum hydroxide, ferric hydroxide, barium sulfate, calcium sulfate, sodium sulfate, calcium oxalate, calcium carbonate, barium carbonate, and magnesium carbonate. The dispersion stabilizer is ordinarily used at a ratio of from 0.1 to 20 parts by mass per 100 parts by mass of the total amount of the polymerizable monomer.

In addition to the dispersion stabilizer, auxiliary stabilizers such as condensation products of diethanolamine and aliphatic dicarboxylic acid, condensation products of urea and formaldehyde, polyvinylpyrrolidone, polyethyleneoxide, polyethyleneimine, tetrametylammoniumhydroxide, gelatin, methylcellulose, polyvinylalcohol, dioctylsulfosuccinate, sorbitan esters, various emulsifiers, or the like, for example, may be used.

One preferable combination is a combination of colloidal silica and a condensation product. A preferable condensation product is a condensation product of diethanolamine and aliphatic dicarboxylic acid, and a condensate of diethanolamine and adipic acid or a condensation product of diethanolamine and itaconic acid is particularly preferable. A condensate is defined by the acid value thereof (units: mgKOH/g). The acid value is preferably not less than 60 and less than 95. A condensate with an acid value of not less than 65 and not greater than 90 is particularly preferable. Further, when an inorganic salt such as sodium chloride or sodium sulfate is added, heat-expandable microspheres having a more uniform particle shape are easily obtained. Sodium chloride is suitably used as an inorganic salt. The amount of the colloidal silica that is used varies depending on the particle size thereof, but the colloidal silica is used at a ratio of ordinarily from 1 to 20 parts by mass and preferably from 2 to 10 parts by mass per 100 parts by mass of the total amount of the polymerizable monomer. The condensation product is ordinarily used at a ratio of from 0.05 to 2 parts by mass per 100 parts by mass of the total amount of the polymerizable monomer. The inorganic salt is used at a ratio of from 0 to 120 parts by mass and in many cases from 0 to 100 parts by mass per 100 parts by mass of the total amount of the polymerizable monomer (“0 parts by mass” means that the composition contains no inorganic salt).

Other preferable combinations are combinations of colloidal silica and water-soluble nitrogen-containing compounds. Examples of water-soluble nitrogen-containing compounds include polydialkylaminoalkyl(meth)acrylates such as polyvinylpyrrolidone, polyethyleneimine, polyoxyethylenealkylamine, polydimethylaminoethylmethacrylate, and polydimethylaminoethylacrylate, polydialkylaminoalkyl(meth)acrylamides such as polydimethylaminopropylacrylamide and polydimethylaminopropylmethacrylamide, polyacrylamides, polycationic acrylamides, polyaminesulfones, and polyallylamines. Of these, combinations of colloidal silica and polyvinylpyrrolidone may be suitably used. Other preferable combinations are combinations of magnesium hydroxide and/or calcium phosphate and an emulsifier.

A colloid of a hardly water-soluble metal hydroxide (for example, magnesium hydroxide) obtained by a reaction of a water-soluble polyvalent metal compound (for example, magnesium chloride) and an alkali hydroxide metal salt (for example, sodium hydroxide) in an aqueous phase can be used as a dispersion stabilizer. In addition, a reaction product of sodium phosphate and calcium chloride in an aqueous phase may be used as calcium phosphate.

An emulsifier is not typically used, but an anionic surfactant such as a dialkylsulfosuccinic acid salt or a phosphoric acid ester of polyoxyethylenealkyl(allyl) ether, for example, may be used as desired.

Further, at least one type of compound selected from the group consisting of alkali nitrite metal salts, stannous chloride, stannic chloride, water-soluble ascorbic acids, and boric acid may also be present as a polymerization aid in the aqueous dispersion medium containing a dispersion stabilizer. When suspension polymerization is performed in the presence of these compounds, agglomeration does not occur between the polymerized particles at the time of polymerization, and heat-expandable microspheres can be stably produced while heat build-up due to polymerization is efficiently eliminated without the polymer adhering to the polymerization vessel wall. Among alkali nitrite metal salts, sodium nitrite or potassium nitrite is preferable from the perspective of the cost or ease of procurement. These compounds are ordinarily used at a ratio of from 0.001 to 1 part by mass and preferably from 0.01 to 0.1 parts by mass per 100 parts by mass of the total amount of the polymerizable monomer.

### 3. Polymerization Initiator

The polymerizable monomer described above can be suspension-polymerized by bringing the monomer into contact with a polymerization initiator in an environment at a prescribed temperature. The polymerization initiator is not particularly limited, and one that is generally used in this field may be used, but an oil-soluble polymerization initiator that is soluble in the polymerizable monomer that is used is preferred. Examples of the polymerization initiator include dialkyl peroxides, diacyl peroxides, peroxyesters, peroxydicarbonates, and azo compounds. More specific examples include dialkyl peroxides such as methyl ethyl peroxide, di-t-butyl peroxide, and dicumyl peroxide; diacyl peroxides such as isobutyl peroxide, benzoyl peroxide, 2,4-dicyclobenzoyl peroxide, and 3,5,5-trimethylhexanoyl peroxide; peroxyesters such as t-butyl peroxypivalate, t-hexyl peroxypivalate, t-butyl peroxyneodecanoate, t-hexyl peroxyneodecanoate, 1-cyclohexyl-1-methylethyl peroxyneodecanoate, 1,1,3,3-tetramethylbutyl peroxyneodecanoate, cumyl peroxyneodecanoate, and (α,α-bis-neodecanoylperoxy)diisopropylbenzene; peroxydicarbonates such as bis(4-t-butylcyclohexyl)peroxydicarbonate, di-n-propyl-oxydicarbonate, diisopropyl peroxydicarbonate (also called “IPP” hereafter), di(2-ethylethylperoxy)dicarbonate, dimethoxybutyl peroxydicarbonate, and di(3-methyl-3-methoxybutylperoxy)dicarbonate; and azo compounds such as 2,2′-azobisisobutyronitrile (hereinafter, referred to as “V-60”), 2,2′-azobis(4-methoxy-2,4-dimethylvaleronitrile), 2,2′-azobis(2,4-dimethylvaleronitrile), and 1,1′-azobis(1-cyclohexanecarbonitrile). The polymerization initiator is ordinarily used at a ratio of from 0.0001 to 3 mass % on the basis of the aqueous dispersion medium.

### 4. Suspension Polymerization

Suspension polymerization is performed in an aqueous dispersion medium and is ordinarily performed in an aqueous dispersion medium containing a dispersion stabilizer (suspending agent). The order in which each component such as a dispersion stabilizer is added to the aqueous dispersion medium is discretionary as long as heat-expandable microspheres having excellent physical properties such as a foaming ratio can be produced, but an aqueous dispersion medium containing a dispersion stabilizer is ordinarily prepared by first adding water and a dispersion stabilizer and then further adding an auxiliary stabilizer, a polymerization aid, or the like as necessary. In suspension polymerization, the optimal pH conditions are preferably selected in accordance with the type of dispersion stabilizer or auxiliary stabilizer that is used. For example, when a silica such as colloidal silica is used as a dispersion stabilizer, polymerization is preferably performed in an acidic environment, so the pH of the system is adjusted to approximately 3 to 4 by adding an acid to the aqueous dispersion medium containing a dispersion stabilizer. In addition, when magnesium hydroxide or calcium phosphate is used as a dispersion stabilizer, polymerization is performed in an alkaline environment.

On the other hand, a monomer mixture containing at least a foaming agent and a polymerizable monomer is prepared separately from the aforementioned aqueous dispersion medium containing a dispersion stabilizer by mixing a foaming agent, a polymerizable monomer, and a crosslinkable monomer or the like as necessary. However, the foaming agent, polymerizable monomer, crosslinkable monomer, and the like may be added to the aforementioned aqueous dispersion medium containing a dispersion stabilizer as long as the object of the present invention is not inhibited. Next, a polymerizable mixture containing at least a foaming agent and a polymerizable monomer is added to the aforementioned aqueous dispersion medium containing a dispersion stabilizer and mixed while stirring. The polymerization initiator may be added to the polymerizable monomer in advance, but in a case where it is necessary to avoid early polymerization, the polymerization initiator may be added and homogenized in the aqueous dispersion medium when the polymerizable mixture containing at least a foaming agent and a polymerizable monomer is added to the aforementioned aqueous dispersion medium containing a dispersion stabilizer and mixed while stirring.

By mixing the polymerizable mixture and the aqueous dispersion medium containing a dispersion stabilizer while stirring, the polymerizable mixture forms liquid droplets in the form of an oil phase in the aqueous dispersion medium containing a dispersion stabilizer, so these can be mixed while stirring so as to be granulated into fine liquid droplets of a desired size. The average particle size of the liquid droplets is preferably roughly the same as the target average particle size (D50) of the heat-expandable microspheres before foaming and is therefore ordinarily within the range of from 100 to 500 μm, preferably from 105 to 400 μm, and more preferably within the range of from 110 to 300 μm.

At the time of stirring and mixing, conditions such as the type or revolution speed of the mixer are set in accordance with the desired particle size of the heat-expandable microspheres. At this time, the conditions are selected taking into consideration the size and shape of the polymerization vessel (polymerization tank, polymerization vessel, ampoule, or the like), the presence or absence of a baffle, and the like. A homogenizer having a high shearing force is preferable as a stirring device, and a continuous high-speed rotary high-shear type stirrer/disperser or a batch high-speed rotary high-shear type stirrer/disperser (batch type high-speed emulsifier/disperser) may be used. In order to obtain the heat-expandable microspheres having an average particle size (D50) of from 100 to 500 μm and an extremely sharp particle size distribution in as indicated by a coefficient of variation of the particle size distribution (logarithmic scale) of not greater than 15%, a method of dispersing the aqueous dispersion medium containing a dispersion stabilizer and the polymerizable mixture while stirring using a batch-type high-speed emulsifier/disperser, ordinarily injecting the obtained dispersion into a polymerization vessel, and then performing suspension polymerization in the polymerization vessel, or a method of supplying the aqueous dispersion medium containing a dispersion stabilizer and the polymerizable mixture into a continuous high-speed rotary high-shear type stirrer/disperser, continuously dispersing both components in the stirrer/disperser while stirring, ordinarily injecting the obtained dispersion into a polymerization vessel, and then performing suspension polymerization in the polymerization vessel is preferable. The peripheral speed when dispersing the aqueous dispersion medium containing a dispersion stabilizer and the polymerizable mixture by mixing while stirring using a batch-type high-speed emulsifier/disperser can be determined taking into consideration the size of the stirring blades, the treatment time, the cracking revolution speed, or the like, but the peripheral speed is preferably from 1.6 to 6.3 m/sec (corresponding to a stirring revolution speed of from 1000 to 4000 rpm at a stirring blade diameter of 30 mm, for example), more preferably from 1.9 to 5.5 m/sec (corresponding to a stirring revolution speed of from 1200 to 3500 rpm at a stirring blade diameter of 30 mm, for example), and even more preferably from 2.4 to 4.7 m/sec (corresponding to a stirring revolution speed of from 1500 to 3000 rpm at a stirring blade diameter of 30 mm, for example). In addition, the temperature when dispersing the aqueous dispersion medium containing a dispersion stabilizer and the polymerizable mixture by mixing while stirring using a batch-type high-speed emulsifier/disperser or when dispersing while continuously stirring in a continuous high-speed rotary high-shear type stirrer/disperser may be determined while taking into consideration the temperature or the like for performing suspension polymerization. The temperature is ordinarily from 0 to 80° C. and in many cases from 10 to 40° C., and the temperature may be normal temperature.

Examples of the method of supplying the aqueous dispersion medium containing a dispersion stabilizer and the polymerizable mixture to a continuous high-speed rotary high-shear type stirrer/disperser include a method of continuously supplying the aqueous dispersion medium containing a dispersion stabilizer and the polymerizable mixture as separate flows at a constant ratio to the continuous high-speed rotary high-shear type stirrer/disperser and a method of injecting the aqueous dispersion medium containing a dispersion stabilizer and the polymerizable mixture into a dispersion tank, subjecting both components to primary dispersion while stirring in the dispersion tank, and then supplying the obtained primary dispersion to the continuous high-speed rotary high-shear type stirrer/disperser.

The polymerization (suspension polymerization) reaction is ordinarily performed while stirring for 5 to 50 hours at a temperature of from 40 to 80° C. in a polymerization vessel that has been degassed or replaced with an inert gas such as nitrogen gas. The heat-expandable microspheres produced by polymerization form an oil phase (solid phase), so an aqueous phase containing the aqueous dispersion medium is separated and removed from the heat-expandable microspheres by a separation method which is itself known, such as filtration, centrifugation, or precipitation, for example. The obtained heat-expandable microspheres are dried at a relatively low temperature at which the foaming agent is not gasified as necessary.

Further, by heat-treating the obtained heat-expandable microspheres at a temperature equal to or lower than the foaming starting temperature as necessary, it is possible to enhance the uniformity of foaming (thermal expansion) or the characteristics of the foamed particles. Further, such heat treatment allows the heat-expandable microspheres to be adjusted so that foaming is initiated at a temperature lower than the foaming starting temperature. Heat treatment can be selected appropriately under conditions at a temperature ordinarily at least 15° C. lower and in many cases at least 20° C. lower than the foaming starting temperature of the heat-expandable microspheres prior to heat treatment for ordinarily 10 seconds to 15 minutes and in many cases from 30 seconds to 10 minutes. As a result of heat treatment, the heat-expandable microspheres can be prepared so as to begin foaming within a temperature range of from 5 to 70° C. lower and in many cases from 10 to 60° C. lower than the foaming starting temperature.

Aspects for carrying out the present invention may assume the following such configurations.

[1] Heat-expandable microspheres having a foaming agent encapsulated in an outer shell of a polymer, the heat-expandable microspheres having an average particle size (D50) before foaming of from 100 to 500 μm, and a coefficient of variation of a particle size distribution before foaming (logarithmic scale) of not greater than 15%.
[2] The heat-expandable microspheres according to [1], wherein an average particle size of foamed particles formed by thermally expanding the heat-expandable microspheres is from 200 to 1000 μm.
[3] The heat-expandable microspheres according to [1] or [2], wherein a foaming starting temperature is not lower than 150° C.
[4] The heat-expandable microspheres according to any one of [1] to [3], wherein the polymer contains (meth)acrylonitrile as a monomer unit.
[5] The heat-expandable microspheres according to [4], wherein the polymer further contains at least one type selected from the group consisting of vinylidene chloride, acrylic acid esters, methacrylic acid esters, styrene, acrylic acid, methacrylic acid, and vinyl acetate as a monomer unit.
[6] A paint or molded product containing the heat-expandable microspheres according to any one of [1] to [5].
[7] A laminate having a coating film containing foamed particles formed by thermally expanding the heat-expandable microspheres according to any one of [1] to [5], or a molded product containing the foamed particles.
[8] A method for producing heat-expandable microspheres having an average particle size (D50) before foaming of from 100 to 500 μm, the method including performing suspension polymerization on a polymerizable mixture containing at least a foaming agent and a polymerizable monomer in an aqueous dispersion medium containing a dispersion stabilizer so as to produce heat-expandable microspheres having a foaming agent encapsulated in an outer shell of the produced polymer.

### EXAMPLES

The present invention will be described in further hereinafter using examples and comparative examples, but the present invention is not limited to these examples. The measurement methods for the characteristics of the heat-expandable microspheres are as follows.

### Average Particle Size and Coefficient of Variation of Particle Size Distribution (Logarithmic Scale)

The average particle size (D50) of the heat-expandable microspheres before foaming, the average value of the particle size distribution (logarithmic scale), and the standard deviation (logarithmic scale) were measured and calculated using an SALD-3100 manufactured by Shimadzu Corporation. In addition, the coefficient of variation of particle size distribution (logarithmic scale) was calculated by the method described above. The average particle size of the foamed particles was calculated based on observations using the method described above.

### Foaming Starting Temperature

The foaming starting temperature of the heat-expandable microspheres was measured using a model TMA/SDTA840 thermomechanical analysis apparatus manufactured by Mettler-Toledo International Inc. Specifically, 0.25 mg of heat-expandable microspheres are used as a sample, which is heated at a heating rate of 5° C./min, and the temperature at which a displacement in the height of the sample inside the container begins (Ts; units: ° C.) is determined.

### Example 1

### Preparation of Aqueous Dispersion Medium Containing Dispersion Stabilizer

An aqueous dispersion medium containing a dispersion stabilizer was prepared by adding 6 g of colloidal silica serving as a dispersion stabilizer (30 g of a silica dispersion with a solid content of 20 mass %), 0.7 g of a condensation product of diethanolamine and adipic acid serving as an auxiliary stabilizer (acid value: 75 mgKOH/g) (1.4 g of a dispersion with a solid content of 50 mass %), and 0.09 g of sodium nitrite serving as a polymerization aid to 534 g of saltwater (NaCl concentration: 25 mass %). The pH of the aqueous dispersion medium containing a dispersion stabilizer was adjusted to 3.5 by adding 5 mg of hydrochloric acid to the aqueous dispersion medium.

### Preparation of Polymerizable Mixture Containing Foaming Agents and Polymerizable Monomers

On the other hand, an oily mixture was prepared using 100.5 g of acrylonitrile, 46.5 g of methacrylonitrile, and 3.0 g of methyl methacrylate serving as polymerizable monomers (mass ratio: acrylonitrile/methacrylonitrile/methyl methacrylate=67/31/2) and 1.85 g of isopentane (1.23 parts by mass per 100 parts by mass of the total amount of the polymerizable monomers), 11.1 g of isooctane (7.4 parts by mass per 100 parts by mass of the total amount of the polymerizable monomers), and 14.8 g of isododecane (9.87 parts by mass per 100 parts by mass of the total amount of the polymerizable monomers) serving as foaming agents (the total amount of the foaming agents was 18.5 parts by mass per 100 parts by mass of the total amount of the polymerizable monomers). Further, a polymerizable mixture containing at least a foaming agent and a polymerizable monomer was prepared by adding 0.75 g of ethylene glycol dimethacrylate (EDMA) serving as a crosslinkable monomer and 1.8 g of V-60 (2,2′-azobis-isobutyronitrile) serving as a polymerization initiator.

The aqueous dispersion medium containing a dispersion stabilizer and the polymerizable mixture were mixed while stirring for a treatment time of 50 seconds at normal temperature and at a peripheral speed of 3.1 m/sec (stirring blade diameter: 30 mm, stirring revolution speed: 2000 rpm) using a batch-type high-speed emulsifier/disperser “TOKUSHU KIKA ROBOMICS (trade name)”, and fine liquid droplets of the polymerizable mixture were thereby granulated. The obtained aqueous dispersion medium containing fine liquid droplets of the polymerizable mixture was charged into an ampoule serving as a polymerization vessel (volume: 0.63 L) and was subjected to suspension polymerization for 20 hours at a temperature of 60° C. The particles of the produced polymer were subjected to Nutsche filtration, washed with water, and dried for 2 hours at a temperature of 40° C. to obtain heat-expandable microspheres. The average particle size (D50) of the obtained heat-expandable microspheres (also simply called the “average particle size” hereafter) was 174 μm, the coefficient of variation of the particle size distribution (logarithmic scale) (also simply called the “coefficient of variation” hereafter) was 9.3%, and the foaming starting time was 175° C.

After the heat-expandable microspheres were heat-treated in advance for 5 minutes at a temperature of 150° C. (the heat-expandable microspheres after heat treatment began to foam at a temperature approximately 35° C. lower than the foaming starting temperature), the microspheres were subjected to free foaming for 5 minutes at a temperature of 180° C. to obtain foamed particles. The obtained foamed particles had an average particle size of 417 μm, and the particles retained their shape even in a hot isotropic pressure (HIP) test using argon gas at a temperature of 40° C. and a pressure of 600 kg/cm²) and retained their shape even in a cold isotropic pressure (CIP) test using water at a temperature of 25° C. and a pressure of 300 kg/cm². The foaming agent content (foaming agent content per 100 parts by mass of the resin (units: part by mass)), the average particle size (D50), the coefficient of variation of the particle size distribution (logarithmic scale), and the foaming starting temperature of the heat-expandable microspheres as well as the average particle size of the foamed particles (called the “characteristics of the heat-expandable microspheres and the like” hereafter) are shown in Table 1.

### Example 2

Heat-expandable microspheres were obtained in the same manner as in Example 1 with the exception that the composition of the polymerizable monomers were changed to a composition of 103.5 g of acrylonitrile, 45.0 g of methacrylonitrile, and 1.5 g of methyl methacrylate (mass ratio: acrylonitrile/methacrylonitrile/methyl methacrylate=69/30/1) and that the composition of the foaming agents were changed to a composition of 1.95 g of isopentane (1.3 parts by mass per 100 parts by mass of the total amount of the polymerizable monomers), 15.15 g of isooctane (10.1 parts by mass per 100 parts by mass of the total amount of the polymerizable monomers), and 10.65 g of isododecane (7.1 parts by mass per 100 parts by mass of the total amount of the polymerizable monomers) to prepare an oily mixture (the total amount of the foaming agents was 18.5 parts by mass per 100 parts by mass of the total amount of the polymerizable monomers). The characteristics of the heat-expandable microspheres and the like are shown in Table 1.

### Example 3

Heat-expandable microspheres were obtained in the same manner as in Example 1 with the exception that the composition of foaming agents were changed to a composition of 3.0 g of isopentane (2.0 parts by mass per 100 parts by mass of the total amount of the polymerizable monomers), 18.0 g of isooctane (12.0 parts by mass per 100 parts by mass of the total amount of the polymerizable monomers), and 24.0 g of isododecane (16.0 parts by mass per 100 parts by mass of the total amount of the polymerizable monomers) to prepare an oily mixture (the total amount of the foaming agents was 30.0 parts by mass per 100 parts by mass of the total amount of the polymerizable monomers), and that the temperature of free foaming was changed to 160° C. The characteristics of the heat-expandable microspheres and the like are shown in Table 1.

### Example 4

### Preparation of Aqueous Dispersion Medium Containing Dispersion Stabilizer

An aqueous dispersion medium containing a dispersion stabilizer was prepared by adding 42 g of colloidal silica serving as a dispersion stabilizer (210 g of a silica dispersion with a solid content of 20 mass %), 4.9 g of a condensation product of diethanolamine and adipic acid serving as an auxiliary stabilizer (acid value: 75 mgKOH/g) (9.8 g of a dispersion with a solid content of 50 mass %), and 0.84 g of sodium nitrite serving as a polymerization aid to 4984 g of saltwater (NaCl concentration: 25 mass %). The pH of the aqueous dispersion medium containing a dispersion stabilizer was adjusted to 3.5 by adding 45 mg of hydrochloric acid to the aqueous dispersion medium.

### Preparation of Polymerizable Mixture Containing Foaming Agents and Polymerizable Monomers

On the other hand, an oily mixture was prepared using 983 g of acrylonitrile, 434 g of methacrylonitrile, and 28 g of methyl methacrylate serving as polymerizable monomers (mass ratio: acrylonitrile/methacrylonitrile/methyl methacrylate=67/31/2) and 28 g of isopentane (2.0 parts by mass per 100 parts by mass of the total amount of the polymerizable monomers), 168 g of isooctane (12.0 parts by mass per 100 parts by mass of the total amount of the polymerizable monomers), and 224 g of isododecane (16.0 parts by mass per 100 parts by mass of the total amount of the polymerizable monomers) serving as foaming agents (the total amount of the foaming agents was 30.0 parts by mass per 100 parts by mass of the total amount of the polymerizable monomers). Further, a polymerizable mixture containing at least a foaming agent and a polymerizable monomer was prepared by adding 7 g of ethylene glycol dimethacrylate (EDMA) serving as a crosslinkable monomer and 16.8 g of V-60 (2,2′-azobis-isobutyronitrile) serving as a polymerization initiator.

The aqueous dispersion medium containing a dispersion stabilizer and the polymerizable mixture were charged into a polymerization vessel (volume: 10 L) with a stirrer, and suspension polymerization was performed at a polymerization revolution speed of 250 rpm for 13.5 hours at a temperature of 60° C. and then for 10.5 hours at a temperature of 70° C. The particles of the produced polymer were filtered using a Nutsche (Buechner funnel), washed with water, and dried for 2 hours at a temperature of 40° C. to obtain heat-expandable microspheres. The characteristics of the heat-expandable microspheres and the like are shown in Table 1.

### Example 5

Heat-expandable microspheres were obtained in the same manner as in Example 4 with the exception that the composition of the foaming agents were changed to a composition of 28 g of isopentane (1.63 parts by mass per 100 parts by mass of the total amount of the polymerizable monomers), 140 g of isooctane (10 parts by mass per 100 parts by mass of the total amount of the polymerizable monomers), and 187.25 g of isododecane (13.38 parts by mass per 100 parts by mass of the total amount of the polymerizable monomers) to prepare an oily mixture (the total amount of the foaming agents was 25.0 parts by mass per 100 parts by mass of the total amount of the polymerizable monomers), that the crosslinkable monomer was changed to 21 g of diethylene glycol dimethacrylate (DEDMA), and that the polymerization revolution speed was set to 350 rpm. The characteristics of the heat-expandable microspheres and the like are shown in Table 1.

### Example 6

Heat-expandable microspheres were obtained in the same manner as in Example 4 with the exception that the composition of the foaming agents were changed to a composition of 22.75 g of isopentane (1.63 parts by mass per 100 parts by mass of the total amount of the polymerizable monomers), 140 g of isooctane (10 parts by mass per 100 parts by mass of the total amount of the polymerizable monomers), and 187.25 g of isododecane (13.38 parts by mass per 100 parts by mass of the total amount of the polymerizable monomers) to prepare an oily mixture (the total amount of the foaming agents was 25.0 parts by mass per 100 parts by mass of the total amount of the polymerizable monomers), that the crosslinkable monomer was changed to 15.4 g of diethylene glycol dimethacrylate (DEDMA), and that the polymerization revolution speed was set to 350 rpm. The characteristics of the heat-expandable microspheres and the like are shown in Table 1.

### Example 7

### Preparation of Aqueous Dispersion Medium Containing Dispersion Stabilizer

An aqueous dispersion medium containing a dispersion stabilizer was prepared by adding 0.72 kg of colloidal silica serving as a dispersion stabilizer (3.6 kg of a silica dispersion with a solid content of 20 mass %), 0.084 kg of a condensation product of diethanolamine and adipic acid serving as an auxiliary stabilizer (acid value: 75 mgKOH/g) (0.168 g of a dispersion with a solid content of 50 mass %), and 14.4 kg of sodium nitrite serving as a polymerization aid to 85.44 kg of saltwater (NaCl concentration: 25 mass %). The pH of the aqueous medium containing a dispersion stabilizer was adjusted to 3.5 by adding 0.82 kg of hydrochloric acid to the aqueous dispersion medium.

### Preparation of Polymerizable Mixture Containing Foaming Agents and Polymerizable Monomers

On the other hand, an oily mixture was prepared using 16.08 kg of acrylonitrile, 7.44 kg of methacrylonitrile, and 0.48 kg of methyl methacrylate serving as polymerizable monomers (mass ratio: acrylonitrile/methacrylonitrile/methyl methacrylate=67/31/2) and 0.48 kg of isopentane (2.0 parts by mass per 100 parts by mass of the total amount of the polymerizable monomers), 2.88 kg of isooctane (12.0 parts by mass per 100 parts by mass of the total amount of the polymerizable monomers), and 3.84 kg of isododecane (16.0 parts by mass per 100 parts by mass of the total amount of the polymerizable monomers) serving as foaming agents (the total amount of the foaming agents was 30.0 parts by mass per 100 parts by mass of the total amount of the polymerizable monomers). Further, a polymerizable mixture containing at least a foaming agent and a polymerizable monomer was prepared by adding 0.12 kg of ethylene glycol dimethacrylate (EDMA) serving as a crosslinkable monomer and 0.288 kg of V-60 (2,2′-azobis-isobutyronitrile) serving as a polymerization initiator.

The obtained aqueous dispersion medium containing fine liquid droplets of the polymerizable mixture was charged into a polymerization vessel (volume: 100 L) with a stirrer, and suspension polymerization was performed at a polymerization revolution speed of 148 rpm for 13.5 hours at a temperature of 60° C. and then for 10.5 hours at a temperature of 70° C. The particles of the produced polymer were filtered using a Nutsche (Buechner funnel), washed with water, and dried for 2 hours at a temperature of 40° C. to obtain heat-expandable microspheres. The characteristics of the heat-expandable microspheres and the like are shown in Table 1.

### Example 8

Heat-expandable microspheres were obtained in the same manner as in Example 7 with the exception that the composition of the foaming agents were changed to a composition of 0.3 kg of isopentane (1.23 parts by mass per 100 parts by mass of the total amount of the polymerizable monomers), 1.78 kg of isooctane (7.4 parts by mass per 100 parts by mass of the total amount of the polymerizable monomers), and 2.37 kg of isododecane (9.87 parts by mass per 100 parts by mass of the total amount of the polymerizable monomers) to prepare an oily mixture (the total amount of the foaming agents was 18.5 parts by mass per 100 parts by mass of the total amount of the polymerizable monomers). The characteristics of the heat-expandable microspheres and the like are shown in Table 1.

### Example 9

Heat-expandable microspheres were obtained in the same manner as in Example 7 with the exception that the composition of the foaming agents were changed to a composition of 2.23 kg of isooctane (9.3 parts by mass per 100 parts by mass of the total amount of the polymerizable monomers) and 2.57 kg of isododecane (10.7 parts by mass per 100 parts by mass of the total amount of the polymerizable monomers) to prepare an oily mixture (the total amount of the foaming agents was 20 parts by mass per 100 parts by mass of the total amount of the polymerizable monomers), and that the crosslinkable monomer was changed to 0.24 kg of diethylene glycol dimethacrylate (DEDMA). The characteristics of the heat-expandable microspheres and the like are shown in Table 1.

### Example 10

### Preparation of Aqueous Dispersion Medium Containing Dispersion Stabilizer

An aqueous dispersion medium containing a dispersion stabilizer was prepared by adding 9 kg of colloidal silica serving as a dispersion stabilizer (45 kg of a silica dispersion with a solid content of 20 mass %), 1.05 g of a condensation product of diethanolamine and adipic acid serving as an auxiliary stabilizer (acid value: 75 mgKOH/g) (21 kg of a dispersion with a solid content of 50 mass %), and 0.180 kg of sodium nitrite serving as a polymerization aid to 1068 kg of saltwater (NaCl concentration: 25 mass %). The pH of the aqueous dispersion medium containing a dispersion stabilizer was adjusted to 3.5 by adding 10.2 kg of hydrochloric acid to the aqueous dispersion medium.

### Preparation of Polymerizable Mixture Containing Foaming Agents and Polymerizable Monomers

On the other hand, an oily mixture was prepared using 201 kg of acrylonitrile, 93 kg of methacrylonitrile, and 6 kg of methyl methacrylate serving as polymerizable monomers (mass ratio: acrylonitrile/methacrylonitrile/methyl methacrylate=67/31/2) and 3.69 kg of isopentane (1.23 parts by mass per 100 parts by mass of the total amount of the polymerizable monomers), 22.2 kg of isooctane (7.4 parts by mass per 100 parts by mass of the total amount of the polymerizable monomers), and 29.61 kg of isododecane (9.87 parts by mass per 100 parts by mass of the total amount of the polymerizable monomers) serving as foaming agents (the total amount of the foaming agents was 18.5 parts by mass per 100 parts by mass of the total amount of the polymerizable monomers). Further, a polymerizable mixture containing at least a foaming agent and a polymerizable monomer was prepared by adding 1.5 g of ethylene glycol dimethacrylate (EDMA) serving as a crosslinkable monomer and 3.6 g of V-60 (2,2′-azobis-isobutyronitrile) serving as a polymerization initiator.

The aqueous dispersion medium containing a dispersion stabilizer and the polymerizable mixture were charged into a polymerization vessel (volume: 2 TON) with a stirrer serving as a polymerization vessel, and suspension polymerization was performed at a polymerization revolution speed of 69 rpm for 13.5 hours at a temperature of 60° C. and then for 10.5 hours at a temperature of 70° C. The particles of the produced polymer were filtered using a Nutsche (Buechner funnel), washed with water, and dried for 2 hours at a temperature of 40° C. to obtain heat-expandable microspheres. The characteristics of the heat-expandable microspheres and the like are shown in Table 1.

### Comparative Example 1

Heat-expandable microspheres were obtained in the same manner as in Example 1 with the exception that at the time of the granulation of fine liquid droplets of the polymerizable mixture, the stirring conditions of the batch-type high-speed emulsifier/disperser were changed to a treatment time of 50 seconds at a peripheral speed of 14.1 m/sec (stirring blade diameter: 30 mm, stirring revolution speed: 9000 rpm). The characteristics of the heat-expandable microspheres and the like are shown in Table 1.

### Comparative Example 2

Heat-expandable microspheres were obtained in the same manner as in Example 2 with the exception that at the time of the granulation of fine liquid droplets of the polymerizable mixture, the stirring conditions of the batch-type high-speed emulsifier/disperser were changed to a treatment time of 50 seconds at a peripheral speed of 14.1 m/sec (stirring blade diameter: 30 mm, stirring revolution speed: 9000 rpm), and that the temperature of free foaming was changed to 190° C. The characteristics of the heat-expandable microspheres and the like are shown in Table 1.

### Comparative Example 3

An aqueous dispersion medium containing a dispersion stabilizer and the polymerizable mixture described above were mixed while stirring for a treatment time of 60 seconds at normal temperature and at a peripheral speed of 23.0 m/sec (stirring blade diameter: 55 mm, stirring revolution speed: 8000 rpm) using a batch-type high-speed emulsifier/disperser “PRIMIX AUTO MIXER40”, and fine liquid droplets of the polymerizable mixture were thereby granulated. Heat-expandable microspheres were obtained in the same manner as in Example 4 with the exception that the obtained aqueous dispersion medium containing fine liquid droplets of the polymerizable mixture were charged into a polymerization vessel (volume: 10 L) with a stirrer, and that the polymerization revolution speed was set to 450 rpm. The characteristics of the heat-expandable microspheres and the like are shown in Table 1.

### Comparative Example 4

Heat-expandable microspheres were obtained in the same manner as in Example 4 with the exception that the polymerization revolution speed was set to 450 rpm. The characteristics of the heat-expandable microspheres and the like are shown in Table 1.

TABLE 1

| | | Units | Example 1 | Example 2 | Example 3 | Example 4 | Example 5 | Example 6 | Example 7 | Example 8 |
|---|---|---|---|---|---|---|---|---|---|---|
| Heat- | Foaming agent | part by | 18.5 | 18.5 | 30.0 | 30.0 | 25.0 | 25.0 | 30.0 | 18.5 |
| expandable | content | mass | | | | | | | | |
| microspheres | Average particle | μm | 174 | 142 | 162 | 173 | 101 | 100 | 117 | 116 |
| | size (D50) | | | | | | | | | |
| | Coefficient of | % | 9.3 | 10.0 | 11.0 | 3.2 | 4.3 | 4.4 | 3.8 | 3.1 |
| | variation (Cᵥ) | | | | | | | | | |
| | Foaming | ° C. | 175 | 180 | 169 | 185 | 186 | 190 | 191 | 181 |
| | starting | | | | | | | | | |
| | temperature | | | | | | | | | |
| Foamed | Average particle | μm | 417 | 330 | 387 | 295 | 294 | 332 | 318 | 343 |
| particles | size | | | | | | | | | |

| | | | | Example | Comparative | Comparative | Comparative | Comparative |
|---|---|---|---|---|---|---|---|---|
| | | Units | Example 9 | 10 | Example 1 | Example 2 | Example 3 | Example 4 |
| Heat-expandable | Foaming agent | part by | 20.0 | 18.5 | 18.5 | 18.5 | 30.0 | 30.0 |
| microspheres | content | mass | | | | | | |
| | Average particle | μm | 111 | 105 | 50 | 52 | 49 | 69 |
| | size (D50) | | | | | | | |
| | Coefficient of | % | 3.8 | 7.2 | 18.6 | 16.1 | 4.6 | 5.4 |
| | variation (Cᵥ) | | | | | | | |
| | Foaming | ° C. | 211 | 186 | 195 | 213 | 197 | 230 |
| | starting | | | | | | | |
| | temperature | | | | | | | |
| Foamed particles | Average particle | μm | 310 | 306 | 164 | 190 | 159 | 217 |
| | size | | | | | | | |

Table 1 shows that the heat-expandable microspheres of Examples 1 to 10 having a foaming agent encapsulated in the outer shell of a polymer, wherein the average particle size (D50) before foaming is from 100 to 500 μm and the coefficient of variation of the particle size distribution before foaming (logarithmic scale) is not greater than 15%, are balanced heat-expandable microspheres which have a large diameter in terms of the average particle size (D50) before foaming and in which decreases in foaming starting temperature are suppressed, and that large-diameter foamed particles having an average particle size of from 294 to 417 μm and having high shape retention are obtained.

In contrast, it can be seen that the heat-expandable microspheres of Comparative Examples 1 to 4 having a foamed agent encapsulated in the outer shell of a polymer, wherein the average particle size (D50) before foaming is less than 100 μm and the coefficient of variation of the particle size distribution before foaming (logarithmic scale) exceeds 15%, only yield small-diameter foamed particles having an average particle size of less than 200 μm, and it was inferred that it would be difficult to obtain foamed particles having high shape retention.

### INDUSTRIAL APPLICABILITY

The present invention provides heat-expandable microspheres having a foaming agent encapsulated in an outer shell of a polymer, the heat-expandable microspheres having an average particle size (D50) before foaming of from 100 to 500 nm, and a coefficient of variation of a particle size distribution before foaming (logarithmic scale) of not greater than 15%. Therefore, the present invention can provide heat-expandable microspheres with which large-diameter foamed particles which are lightweight and have improved strength, cushioning properties, and the like can be formed, which yields high industrial applicability.

In addition, the present invention provides a method for producing the heat-expandable microspheres described above including performing suspension polymerization on a polymerizable mixture containing at least a foaming agent and a polymerizable monomer in an aqueous dispersion medium containing a dispersion stabilizer so as to produce heat-expandable microspheres having a foaming agent encapsulated in an outer shell of the produced polymer. Therefore, it is possible to provide a method of easily producing the heat-expandable microspheres, which yields high industrial applicability.

1. Heat-expandable microspheres having a foaming agent encapsulated in an outer shell of a polymer, the heat-expandable microspheres having an average particle size (D50) before foaming of from 100 to 500 μm, and a coefficient of variation of a particle size distribution before foaming (logarithmic scale) of not greater than 15%;
the outer shell of the polymer comprising from 25 to 100 mass % of a mixture of acrylonitrile and methacrylonitrile and from 0 to 75 mass % of at least one type of monomer selected from the group consisting of vinylidene chloride, acrylic acid esters, methacrylic acid esters, styrene, acrylic acid, methacrylic acid, and vinyl acetate;
the foaming agent comprising isopentane, isooctane, and isododecane; and
a foaming starting time being from 155 to 210° C.

2. The heat-expandable microspheres according to claim 1, wherein an average particle size of foamed particles formed by thermally expanding the heat-expandable microspheres is from 200 to 1000 μm.

3. (canceled)

4. (canceled)

5. (canceled)

6. A paint or molded product comprising the heat-expandable microspheres according to claim 1.

7. A laminate comprising a coating film containing foamed particles formed by thermally expanding the heat-expandable microspheres according to claim 1, or a molded product comprising the foamed particles.

8. (canceled)
